(19) United States
(12) Patent Application Publication
(10) Pub. No.: US 2009/0223313 A1
(43) Pub. Date: Sep. 10, 2009

(54) Drive apparatus for a swing-out element of a motor vehicle

(76) Inventors: Manfred STENZEL, Bamberg (DE); Uwe Sommer, Effelder (DE)

Correspondence Address: Muncy, Geissler, Olds & Lowe, PLLC, P.O. BOX 1364, FAIRFAX, VA, 22038-1364, US

(21) Appl. No.: 12/395,006

(22) Filed: Feb. 27, 2009

(30) Foreign Application Priority Data
Mar. 6, 2008 (DE) DE202008003169.9

(51) Int. Cl. E05F 15/12; F16H 21/16; B60J 1/14

(52) U.S. Cl. 74/89.14; 74/89.16

(57) ABSTRACT

A drive apparatus is provided for a swing-out element of a motor vehicle, in particular for a swiveling swing-out window, which is automatically adjustable between an open position and a closed position along a movement path, including a driving gear driven by an electric motor, to which a swing-out lever connected to the swing-out element is coupled at a pivot point that is guided at a radial distance in relation to the rotary axle of the driving gear on a guide path deviating from a circular path, the distance decreasing along the guide path from the open position of the swing-out element to the closed position.

This nonprovisional application claims priority under 35 U.S.C. § 119(a) to German Patent Application No. 20 2008 003 169.9, which was filed in Germany on Mar. 6, 2008, and which is herein incorporated by reference.

### BACKGROUND OF THE INVENTION

1. Field of the Invention

The invention relates to a drive apparatus for a swing-out element of a motor vehicle, comprising a driving gear driven by an electric motor, to which a swing-out lever connected to the swing-out element is coupled at a pivot point that is guided at a radial distance from the rotary axle of the driving gear. In this case, a swing-out element is understood to be, in particular, a swiveling, i.e. unilaterally hinged, swing-out closing part, for example a swing-out window, a pop-up roof or the like.

2. Description of the Background Art

A drive mechanism is known from DE 197 57 346 C2 which corresponds to U.S. Pat. No. 6,056,348, and in which the driving force of an electric motor is transmittable via a reduction gear unit to a first connecting member that forms a single piece with an output shaft and to a swiveling window pane via a second connecting member coupled with the first connecting member. During an opening or closing movement of the window pane, the connecting point between the two connecting members moves approximately 180° along an arc-shaped path, while the connecting point between the second connecting member and the window pane moves back and forth along a straight path. The arc-shaped path of the connecting point runs on the side of the output shaft situated opposite a swivel hinge for hinging the window pane, the output shaft representing the circle center of a semicircular path. In a specific embodiment, the second connecting member between the connecting point and the window pane is designed in the shape of an arc and thus surrounds the output shaft even when the swing-out window is closed.

In a window actuator known from DE 42 18 507 C2 which corresponds to U.S. Pat. Nos. 5,385,061 and 5,161,419, comprising an electric motor drive and a multistage spindle gear unit, as well as comprising a similar swivel lever mechanism having two levers that are interconnected in an articulated manner and whose pivot point, in turn, is swiveled around a rotary shaft axle along an arc-shaped path for the purpose of opening and closing the swing-out side window, the pivot point is located on the side opposite the window pane, beneath the rotary axle, when the window pane is in the closed position. This protects the window pane against unwanted (manual) opening.

Drive apparatuses operating according to the principle of a linear drive for swing-out elements of this type are known from the documents DE 196 23 317 C2 and DE 198 49 246 A1, an electric motor moving a telescopically movable adjusting element via a gear unit.

If drive apparatuses of this type are also to be operable in so-called automatic mode, they are, in principle, subject to the same legal requirements as window levers for roll-down windows, in which a maximum trap force of normally 100 N, using a so-called 4-mm rod (upper trap gap limit), is permitted during automatic operation in the closing direction.

### SUMMARY OF THE INVENTION

It is therefore an object of the present invention to provide a drive apparatus of the type stated above, which easily ensures protection against injury (anti-trap control) even during automatic operation.

According to an embodiment of the invention a drive apparatus having a swing-out lever whose pivot position or pivot point passes over an arc-shaped path, it is therefore provided to guide the pivot point on a path deviating from the circular path. The distance between the pivot point and the rotary axis of the driving gear decreases in the direction of the closing position of the swing-out element along the guide path in the manner of a flat spiral path.

Due to the distance between the pivot point and the rotary axle, which changes along with the rotation angle of the driving gear, the length of the lever arm changes accordingly, and the swing-out force, which is also referred to below as the driving force, for opening the swing-out element or the closing force for closing the swing-out element is applied to the end of the lever opposite the rotary axle. The torque resulting from this driving force and the lever arm is dependent on the rotation angle of the driving gear and increases, initially—in principle—on both sides in relation to the closed and open positions of the swing-out element, starting from a central position. As a result of the distance that changes along the movement path of the swing-out element-and thus the correspondingly varying length of the lever arm-it is possible, using a comparatively low-power electric motor, to adjust the driving force practically over the entire movement path of the swing-out element between an open position and a closed position having an injury-proof opening gap below a limit value, in particular the typical anti-trap control value (100 N). This ensures reliable protection against injury, making it possible to operate the swing-out element in automatic mode.

The guide path of the pivot point of the drive apparatus according to the invention, which deviates from the circular path, therefore corresponds to a force curve in which the driving force practically lies below the limit value between a defined open position having a determined rotation angle of the driving gear and the pop-up element's approach to a sealing element on the vehicle body. Only after this practically injury-proof closed position of the swing-out element does the driving force (closing force) increase relatively steeply, as a result of the lever arm, which now decreases in the closing direction, so that a closing force that is sufficient to safely close the swing-out element is provided at the given torque.

The spiral-shaped guide path deviating from the circular path is preferably produced through radially movable guidance of the pivot point. For this purpose, this pivot point is suitably located in a slidable manner in a fork- or slot-shaped sliding profile situated on the circumferential side of the driving gear. Moreover, if the pivot point is guided in a semicircular guide track whose circle center is offset in relation to the rotary axle of the driving gear in the direction of the swing-out element, the pivot point slides increasingly to the outside in the radial direction as a function of the rotation angle, which results in the spiral-shaped guide path, in which the distance between the pivot point and the rotary axle decreases and therefore the length of the lever arm, i.e., the absolute value of the lever arm, also decreases in the closing direction of the swing-out element. In the opening direction, the distance or the lever arm increases according to this guide path.

The guide track is suitably a correspondingly shaped, groove-like profile or guide groove in at least one half of what is suitably a two-part housing of the drive apparatus. If a retaining bolt forming the pivot point is located in this guide groove and additionally guided in the slot-like sliding profile of the driving gear in a manner that permits sliding motion, this practically results in an automatic guidance of the pivot point within the guide groove, as the radial distance between the pivot point and the rotary axle of the driving gear changes as a function of the angle. To minimize rolling friction, a roller is suitably mounted on one or both sides of the retaining bolt, this roller engaging via the retaining bolt with the guide groove or, if necessary, with two guide grooves situated opposite each other on the side of the housing.

According to a suitable design, a spoke-like reinforcing rib is formed on the driving gear between the rotary axle of the driving gear and the holding fork forming the sliding profile. The driving gear is suitably part of a multistage reduction gear unit having a worm gear coupled with the driving gear, the worm gear engaging with a worm mounted on the drive shaft of the electric motor.

A particularly compact design of the drive apparatus is achieved by providing the swing-out lever with an arc-shaped or curved design between the pivot point and the end of the lever coupled with the swing-out element. This avoids the swing-out lever projecting over the rotary axle of the driving gear in the axial direction, even when the swing-out element is in the closed position. For the purpose of simplification and to conserve materials, it is also suitable to provide the outer teeth of the driving gear only on an outer circumference that is relevant for the rotation angle and to design the remaining circumferential area without teeth.

The outer teeth suitably cover a rotation angle of less than or equal to 200°. With regard to an approximately horizontal movement path corresponding to an angular range of 0° in the open position and 180° in the closed position of the swing-out element, the guide track or the guide path of the pivot point suitably covers an angular range of greater than 180°, for example 200° of the rotation angle, up to a rotation angle greater than or equal to 10° in the direction of the open position of the swing-out element. Due to the fact that the 180° dead center is exceeded, a reliable blocking position of the lever mechanism, and thus of the drive apparatus, is achieved in the closed position of the swing-out element. Due to an opening angle other than 0°, the force-dependent dead center is also reliably exceeded in the open position, so that the driving force from the defined open position of the swing-out element is not set or is set only slightly higher than the limiting force.

By guiding the pivot point formed between the driving gear driven by the electric motor and the swing-out lever on the guide path deviating from the circular path, it is possible to provide a particularly low injury or trap force over the entire path of swing-out element movement until passing beyond an injury-proof opening gap to the vehicle body or seal of the vehicle body opening to be closed by the pop-up element, at the same time using a comparatively low-power electric motor. Due to the angle dependency of the lever arm length between the rotary axle and the pivot point, even when the lever arm is vertical (sin α=1, where α is the rotation angle) and therefore the closing force is minimal—at a constant torque—this closing force is still sufficiently high to maintain the adjusting movement of the swing-out element, at least until it enters the seal, without exceeding the predefined trap force as the limiting force along the movement path until reaching an injury-proof gap.

Compared to conventional path guidance methods for closing levers guided on arc-shaped guide paths in drive systems of this type, the spiral-shaped guide path according to the invention practically forms a means for smoothing the driving force available along the movement path and makes it possible to precisely control the increase in force when the swing-out element enters the closed position, as a function of the start of seal deformation. This provides an exclusively mechanical and indirect means of protecting against injury. Compared to a direct-detection protection apparatus, for example in the closing seal of the swing-out window, using an electronic means that detects a trap signal and a corresponding control of the drive to ensure protection against injury, this approach is particularly simple.

The advantages achieved by the invention also include, in particular, the fact that a predefined limit value for protecting against injury is maintained using simple means by providing a guide path deviating from a circular path between an open position and a closed position of the swing-out element. This enables the swing-out element to be closed automatically, in particular using an automatic operation of a swing-out window, without requiring additional complex electronics and sensors. As a result of the achieved smoothing of the angle-dependent force curve, a sufficient closing force is also ensured when the swing-out element enters a closing seal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a partial perspective view of a drive apparatus according to the invention, including a driving gear driven by an electric motor and a swing-out lever coupled thereto in an open housing;

FIG. 2 shows the drive apparatus in a view according to FIG. 1, in which the driving gear has been removed;

FIG. 3 shows a top view of the drive apparatus according to FIG. 1, in which the swing-out lever is in a position corresponding to a closed position;

FIG. 4 shows a view according to FIG. 3, in which the swing-out lever is in an intermediate position between the closed position and an open position;

FIG. 5 shows the lever mechanism in an open position in a view according to FIGS. 3 and 4; and

FIG. 6 shows a force-angle diagram of the quantitative curve of the driving force of the drive apparatus, having a guide path that deviates from the circular shape.

### DETAILED DESCRIPTION

In all figures, corresponding parts are provided with the same reference numerals.

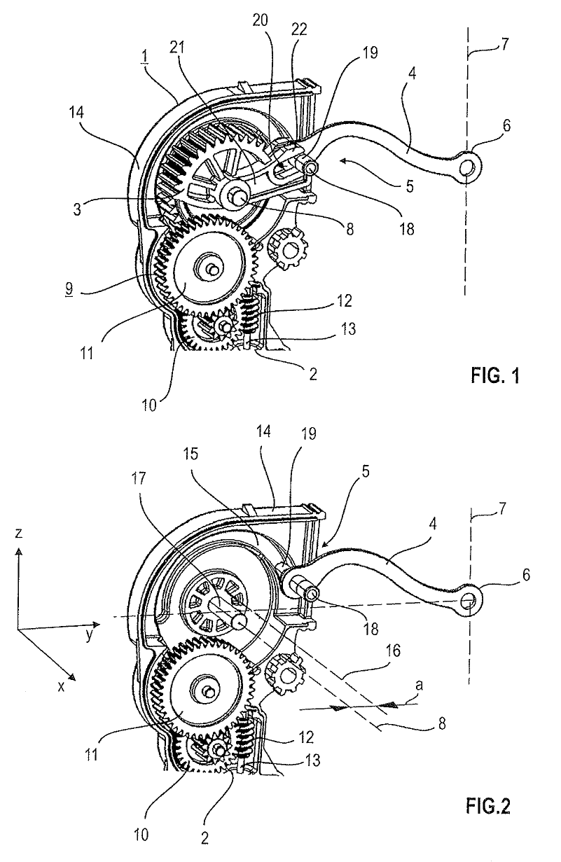

Drive apparatus 1 comprises an electric motor 2, which is only partially visible in FIGS. 1 and 2 and drives a driving gear 3, which, in turn, is coupled with a closing or swing-out lever 4 in a pivot position 5 that is referred to below as a pivot point. Lever end 6 of swing-out lever 4 located opposite pivot point 5 is designed for coupling in a suitably articulated manner to a swing-out element 7, which is indicated only schematically.

Swing-out element 7 is, in principle, a closing part of a motor vehicle, which is usually hinged on one side, for closing an opening in the vehicle body. This may be, in principle, a pop-up roof, a cover, a hood or the like. In the present exemplary embodiment, it is a swiveling side or swing-out window that is usually provided at the back of the motor vehicle.

Driving gear 3, which is run on bearings that allow rotation or swiveling around a rotary axle 8 fixed to the housing, is driven via a multistage reduction gear unit 9 having a worm gear unit 10 that is coupled with driving gear 3 via a toothed gear 11. Worm gear 10 meshes with a worm 12, which is non-rotationally mounted on a drive shaft 13 of electric motor 2. Electric motor 2 and reduction gear unit 9 are situated in a suitably two-part housing, of which only rear housing part 14 is visible when the housing halves are disassembled.

As is comparatively clearly visible in FIG. 2, in which driving gear 3 has been removed, a guide groove 15, referred to below as a guide track, is introduced into housing part 14. Guide track 15 suitably has a semi-circular shape, its circle center 16, however, being offset against rotary axle 8 by a distance a. With regard to the customary motor vehicle coordinate system, the offset by distance a is implemented in the Y direction toward swing-out element 7. Rotary axle 8 of driving gear 3 then runs in the X direction and therefore in the direction of travel, while the illustrated Z direction runs from the vehicle floor to the vehicle roof. Within the housing or housing part 14, driving gear 3 is mounted on a journal 17 fixed to the housing and forming rotary axle 8.

Swing-out lever 4 is coupled to driving gear 3 at coupling point 5 via a retaining bolt 18. Rollers 19 are mounted on this retaining bolt to improve the sliding properties of retaining bolt 18 guided in guide track 15. Retaining bolt 18 and therefore pivot point 5 are located in a slot-like sliding track or profile 20. In the exemplary embodiment, this sliding track 20, which extends radially with regard to rotary axle 8, is formed by a guide fork 22 molded onto a spoke-like reinforcing rib 21 of driving gear 3.

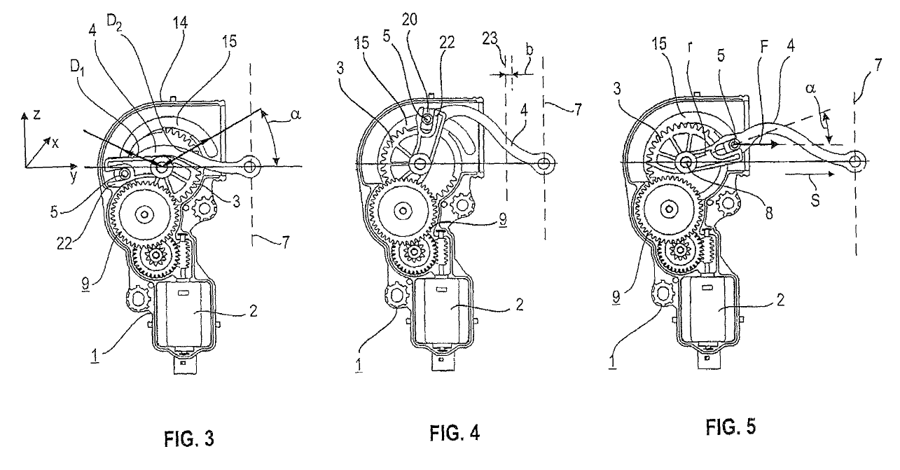

Driving gear 3 forming a toothed gear stage of gear unit 9 of drive apparatus 1 moves swing-out lever 4 along guide track 15 via molded-on guide fork 22. Due to the asymmetrical course of guide track 15 in relation to rotary axle 8, distance D between rotary axle 8 and retaining bolt 18, which is automatically guided in both guide track 15 and guide fork 22, varies along with rotation angle α of driving gear 3 (FIGS. 3 through 5).

As shown in FIGS. 3 through 5, the lever arm or its lever arm length corresponding to distance D between driving axle 8 and coupling point 5 therefore changes as a function of rotation angle α of driving gear 3. In this regard, diameter D of the open position illustrated in FIG. 5 decreases practically continuously in the direction of the closed position of swing-out element 7 illustrated in FIG. 3, which is shown in FIG. 3 by diameters D₁ and D₂, where D₂>D₁. Together with the arc-shaped, suitably semicircular course of guide track 15, on the one hand, and angle-dependent distance D, on the other hand, a flat spiral path is produced overall for the angle-dependent course of pivot point 5. Active, angle-dependent lever arm r (α) therefore increases at small rotation angles α≧0° and decreases at large angles α≧180°.

FIG. 5 shows driving force F, which is applied to pivot point 5 and runs parallel to the Y direction. The figure also shows lever arm r(α), which is dependent on rotation angle α and runs on the Y/Z plane. Torque M of electric motor 2, which is oriented in the X direction, has an absolute value of F=M/(r·sin α) according to vector product M=r×F. At a constant torque M of electric motor 2, driving force F(α) therefore acts in reverse proportion to lever arm r(α) at a given rotation angle α. Since distance D of lever arm r(α) changes as a function of the angle, the guide path of pivot point 5 is a flat spiral that deviates from the circular path.

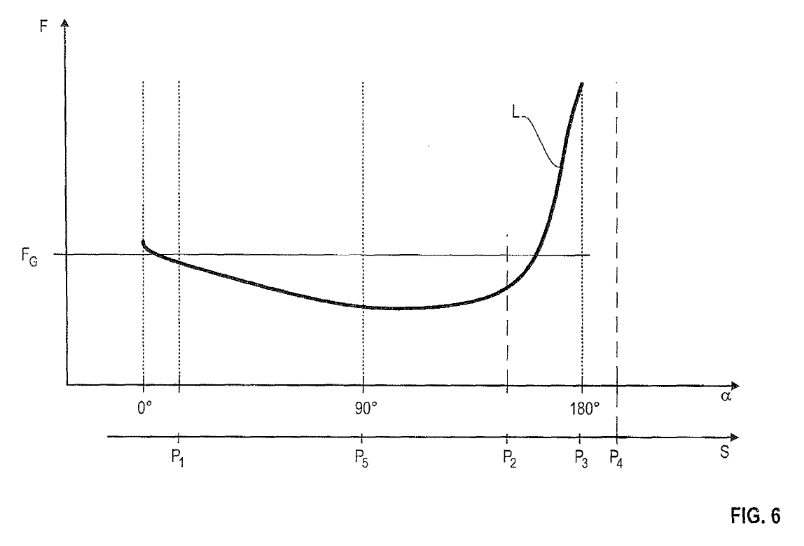

FIG. 6 shows the force ratio of the spiral-shaped guide path of coupling point 5 of drive apparatus 1. The figure first illustrates a force curve of spiral-shaped guide path L that is asymmetrical in relation to the force curve of a circular guide path. Driving force F(α) passes over a comparatively large angular range below a limit value F_{G}. Compared to the symmetrical force curve of a circular guide path, resulting driving force F is greater in the critical angular range, where α=90°, at the same electric motor torque M and it nevertheless passes over a greater angular range below a limit value F_{G}.

Linear movement path S of swing-out element 7, which correlates to rotation angle α, is also plotted in FIG. 6. Maximum open position P₁ of swing-out element 7 is preferably positioned at a rotation angle α≧100 in order to avoid an increase in driving force F above limit value F_{G} of the legally required 100 N. The angular position of open position P₁ may therefore be advantageously defined on the basis of this limit value F_{G}. Illustrated closed position P₃ at a rotation angle α=180° represents the fully closed position of swing-out element 7.

Between open position P₁ and a closed position P₂ of swing-out element 7 corresponding to a movement of swing-out element 7 against or into a seal 23, driving force F is comparatively constant and corresponds to a driving force F that is sufficient to reliably perform a swing-out or closing movement of the swing-out element along movement path S or over corresponding rotation angle α. Position P₄ represents a rotation angle of, for example, α=200°, in order to relieve seal 23 and move swing-out element 7 into an intrusion-proof blocking position. In this blocking position P₄, pivot point 5 is located on the side of rotary axle 8 opposite swing-out element 7 and below rotary axle 8 (FIG. 3). Unwanted, forceful opening of swing-out element 7, in particular a swing-out window, is therefore possible only by destroying drive apparatus 1.

Since guide path L of pivot point 5 has a radial distance D from rotary axle 8 of driving gear 3, which continuously decreases from the defined (maximum) open position P₁ of swing-out element 7 toward the latter's (maximum) closed position P₃, and active lever arm length r(α) therefore decreases accordingly, driving force F is comparatively low along guide path L in the vicinity of open position P₁. Due to guide path L according to the invention, a comparatively flat curve and early increase in driving force F is also produced in the vicinity of closed position P₃.

Due to the corresponding shape of guide path L, including guide track 15 and the slidable coupling of swing-out lever 4 to driving gear 3 at coupling point 5, it is possible to optimally design the available motor power with regard to the desired or required conditions of reliably undershooting the limit value for reliable protection against injury, on the one hand, and sufficient driving force F, on the other hand, when swing-out element 7 enters seal 23 and for sufficient driving force F in critical 90° position P₅ along movement path S of swing-out element 7.

Guide track 15, which, in combination with the sliding guidance of retaining bolt 18 in guide fork 22 and thus with the radial slidability of pivot point 5 in sliding guide 20, produces a non-continuous, spiral-type guide path L, or a shape of guide path L deviating from the circular path, may also be molded into opposite housing part (not illustrated). This may improve the automatic guidance of retaining bolt 18. Due to the desired service life, this, in turn, results in an at least approximately uniform course of guide path L deviating from the circular shape.

The movement of pivot point 5 induced by spiral-shaped guide path L, and thus the movement of swing-out element 7 via swing-out lever 4 along its movement path S between open position P₁ and closed position P₃, provides the advantage that a sufficiently high driving force F is applied for deforming seal 23 practically immediately before closed position P₃ is reached, while simultaneously using a comparatively low-performance electric motor 2. In blocking position P4, on the other hand, the corresponding movement of swing-out element 7 coupled with swing-out lever 4 achieves a reliable locking action to avoid unwanted manual opening of swing-out element 7 beyond actual closing angle α=180° to a stop defined by guide track 15. Using the shape of guide track 15, change in length ΔD of angle-dependent lever arm r(α) and/or offset distance a, the increase in driving force F may also be easily and reliably set to ensure a sufficient pressing force against seal 23. Even before force limit value F_{G} is exceeded, a small, injury-proof opening gap b, where b≦4 mm, is present at this seal position (FIG. 4).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A drive apparatus for a swing-out element of a motor vehicle, in particular for a swiveling swing-out window that is automatically movable between an open position and a closed position along a movement path, the drive apparatus comprising a driving gear driven by an electric motor, to which a swing-out lever connected to the swing-out element is coupled at a pivot point that is guided at a radial distance from the rotary axle of the driving gear, wherein the pivot point is guided on a guide path deviating from a circular path, the distance along the guide path decreasing from the open position of the swing-out element to the closed position.

2. The drive apparatus according to claim 1, wherein the pivot point is formed by a retaining bolt mounted on the swing-out lever.

3. The drive apparatus according to claim 1, wherein the pivot point is movably guided in the radial direction.

4. The drive apparatus according to claim 3, wherein the pivot point is slidably mounted in a fork- or slot-like sliding profile situated on the circumferential side of the driving gear.

5. The drive apparatus according to claim 1, wherein the pivot point is automatically guided in a guide track 3 forming the guide path.

6. The drive apparatus according to claim 5, wherein a groove-like guide track is introduced into at least one housing half.

7. The drive apparatus according to claim 5, wherein the retaining bolt engages with the guide track via a roller.

8. The drive apparatus according to claim 1, wherein the guide path is formed by a semicircular guide track having a center point that is offset by a distance in relation to the rotary axle of the driving gear.

9. The drive apparatus according to claim 1, wherein the guide path has a first angular range and a second angular range of an adjusting angle passed by the pivot point,
the first angular range being assigned to a first section of the movement path, in which the driving force drops below a limit value that is predefined for protection against injury between the open position and a closed position of the swing-out element, and
the second angular range being assigned to a second section of the movement path, having an injury-proof opening gap up to the closed position of the swing-out element, in which second section the driving force is greater than the limit value.

10. The drive apparatus according to claim 1, wherein the driving gear has a reinforcing rib extending radially between the rotary axle and the pivot point.

11. The drive apparatus according to claim 1, wherein the driving gear has a tooth-free circumferential area.

12. The drive apparatus according to claim 1, wherein a multistage reduction gear unit having a worm gear that is coupled with the driving gear and meshes with a worm mounted on the drive shaft of the electric motor.

13. The drive apparatus according to claim 1, wherein, when the swing-out element is closed, the pivot point is located beneath the rotary axle on the side thereof opposite the swing-out element in a blocking position.
